(19) United States
(12) Patent Application Publication
(10) Pub. No.: US 2008/0127348 A1
(43) Pub. Date: May 29, 2008

(54) NETWORK COMPUTER SYSTEM AND METHOD USING THIN USER CLIENT AND VIRTUAL MACHINE TO PROVIDE IMMUNITY TO HACKING, VIRUSES AND SPY WARE

(76) Inventors: Kenneth Largman, San Francisco, CA (US); Anthony B. More, Sebastopol, CA (US); Jeffrey Blair, San Francisco, CA (US); Kip Macy, Incline Village, NV (US)

Correspondence Address: PERKINS COIE LLP, P.O. BOX 2168, MENLO PARK, CA, 94026, US

(21) Appl. No.: 11/848,097

(22) Filed: Aug. 30, 2007

Related U.S. Application Data
(60) Provisional application No. 60/841,850, filed on Aug. 31, 2006.

(51) Int. Cl. G06F 12/14

(52) U.S. Cl. 726/24

(57) ABSTRACT

Network computer system and method using thin user client and virtual machine to provide immunity to hacking, viruses and spyware. A system architecture and computing machine operating as a server executing virtualization software to generate a plurality of virtual machines as virtual desktops for a plurality of users, the environment to support application program processing by a plurality of users and providing a level of isolation that prevents user data and system operating system and application program templates from being corrupted by virus, hacker code or attack, spy-ware, bots, or other malicious code or attacks.

### CROSS-REFERENCE TO RELATED APPLICATIONS

This application claims the benefit of priority to U.S. Provisional Patent Application Ser. No. 60/841,850 filed 31 Aug. 2006 entitled NETWORK COMPUTER SYSTEM AND METHOD USING THIN USER CLIENT AND VIRTUAL MACHINE TO PROVIDE IMMUNITY TO HACKING, VIRUSES AND SPY-WARE, which application is hereby incorporated by reference.

### FIELD OF THE INVENTION

This invention pertains generally to a system architecture and computing machine operating as a server executing virtualization software to generate a plurality of virtual machines as virtual desktops for a plurality of users, the environment to support application program processing by a plurality of users and providing a level of isolation that prevents user data and system operating system and application program templates from being corrupted by virus, hacker code or attack, spy-ware, bots, or other malicious code or attacks.

### BACKGROUND

Business and personal computing and information storage and retrieval have become of ever increasing importance in society. It has moved beyond the domain of scientists, engineers, accountants, and technology oriented individuals to children in elementary school, to the elderly, to on-line shopping, to bill paying, to artistic expression of all types, and even to on-line testing, to name only a few common computing, information gathering and retrieval, and recreational purposes.

Yet with all the sensitive business information, personal information, and personal identify information that may be stored on such computers or communicated between and among such computers or information appliances as they are increasingly being referred to as, these appliances are still susceptible to viruses and viral attach, Trojan horses, hacker attacks and incursions, spy-ware, spy-bots, knowledge-bots, and a myriad of other mechanisms that attempt to gain access to the computer or information appliance either to gather information or to destroy information among the many acts.

While software-based anti-viral, anti-spyware, and other computer programs attempt to detect and stop such acts, and while they are somewhat successful in denying access by known viruses whose viral signatures have been detected and for which consumers have purchased, downloaded, and installed software in advance, these techniques have not been entirely successful. Firstly, they may not generally prevent first waves of attack even for sophisticated users who utilize anti-viral and the like detection and prevention practices, including firewalls, and the like. Secondly, they are even only partially successful when they are installed, activated, updated, and otherwise fully utilized on a computer system. Thirdly, they may sometimes be detected but only after the attach has caused some corruption of the operating system, application programs, user data, or the like; and these components may be difficult for an ordinary consumer to recover, particularly if they do not perform technically demanding backups that are known to be free of contamination on a very regular basis and understand how to recover from such attacks and losses.

Even for administrator managed client-server configurations where user data is stored on a client side computer having its own processor, memory, and mass storage device, attacks or viral contamination may occur. Users of such computers frequently save data on the local mass storage device, such as a local hard disk drive, and if the system administrator does not actively manage and back-up that local storage device, losses may typically occur. Attacks may of course also propagate from a client computer to the server and thereby contaminate other system and user data or files as well.

There therefore remains a need for system, method, computer program and computer program product that overcomes these limitations in conventional systems and methods and provides immunity from viral, hacker, spy-ware, knowledge-bots, and other malicious code or unwelcome visitations, data-mining operations, trespasses, or attacks,

### BRIEF DESCRIPTION OF THE DRAWINGS

Embodiments of the invention are illustrated in the figures. However, the embodiments and figures are illustrative rather than limiting; they provide examples of the invention.

FIG. 1 is a diagrammatic illustration showing an overall system configuration according to an embodiment of the invention.

FIG. 2 is a diagrammatic illustration showing additional details of the client side workstations and server side system and storage according to an embodiment of the invention.

FIG. 3 is a diagrammatic illustration showing additional details of the physical storage system and portions of the storage allocated to the server, to control, and to a plurality of virtual machine desktops according to an embodiment of the invention.

FIG. 4 is a diagrammatic illustration showing aspects of an embodiment of the inventive system under a Xen-type virtualization and control.

FIG. 5 is a diagrammatic illustration showing aspects of an embodiment of the inventive system under a VMware-type virtualization and control.

### SUMMARY

This invention pertains generally to a system architecture and computing machine operating as a server executing virtualization software to generate a plurality of virtual machines as virtual desktops for a plurality of users, the environment to support application program processing by a plurality of users and providing a level of isolation that prevents user data and system operating system and application program templates from being corrupted by virus, hacker code or attack, spy-ware, bots, or other malicious code or attacks.

In one aspect the invention provides a system comprising: a server computer machine including a processor, a memory coupled with the processor, and a persistent physical storage device, the server executing virtualization instructions for generating a plurality of virtual computing machines; a client computing machine coupled with the server over a communications link, the client computing machine operating without the use of an internal persistent storage device; the client computing machine receiving commands and the commands being communicated over the communications link to the server to direct an application program executing on a virtual machine in the server to perform the requested operation; and a write protectable storage device for storing at least an operating system code element and an application program code component for use in operating one of the virtual machines.

In another aspect this system provides that the write protectable storage device includes a plurality of templates for a plurality of virtual computing machines. In another aspect this system provides that the plurality of templates include a master template and a plurality of secondary templates derived from the master template, the plurality of secondary templates including at least an identifier of a difference between

In another aspect the invention provides a server computer machine including: a processor and a memory coupled with the processor, the server computer executing virtualization instructions for generating a plurality of virtual computing machines; a first persistent physical storage device operated in a read and write access mode; a second persistent physical storage device operated in a write protected access mode and storing at least one master template and at least one secondary template derived at least in part from the master template, the master template including at least computer operating system components and application code components and optionally including a default user customization and preference; and a controller for creating and operating the server computer using virtual machines and the write protected storage and templates to maintain virtual computing environments that are free from the effects of malicious code.

In another aspect the invention provides a computer program and computer program product. In another aspect the invention includes a template structure and method for generating derived secondary templates from a primary or master template.

### DETAILED DESCRIPTION OF EXEMPLARY EMBODIMENTS OF THE INVENTION

In the following description, several specific details are presented to provide a thorough understanding of embodiments of the invention. One skilled in the relevant art will recognize, however, that the invention can be practiced without one or more of the specific details, or in combination with other components, and the like. In other instances, well-known implementations or operations are not shown or described in detail to avoid obscuring aspects of various embodiments, of the invention.

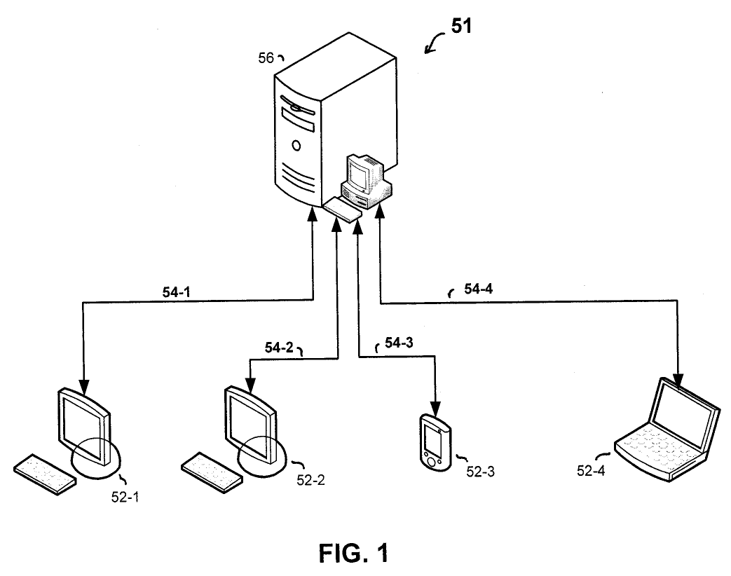

FIG. 1 is an illustration showing an overview of a client-server system architecture 51 in which a plurality of client devices or workstations 52-1, . . . , 52-N are coupled by communications links or paths 54-1, . . . , 54-N to a computer or computing machine 55 configured as a workstation server 56. In one non-limiting embodiment, the client devices or workstations 52-1, . . . , 52-N may be thin client devices or workstations having only minimal processing and storage capabilities. While embodiments of the invention do not preclude the use of client side devices or workstations that have higher levels of processing or storage performance or capabilities, the inventive system, devices, and method of configuring and operating the system do not require such high-end performance client side devices to achieve high levels of performance. In one non-limiting embodiment, the client side devices may be little more than smart terminals capable of communicating with the server 56 and receiving inputs from a user and presenting output to a user in the form of a display device. In one embodiment, the communication links may include Ethernet communications links, but the invention is not limited only to Ethernet communications links, and the different client side devices may be different client side device types and independently may communicate over different communication link types. An exemplary system, including inventive system, server, and methods of operation of the system and server are described in addition detail below.

In the sections that follow, attention is first directed to various exemplary system and device architectures and configurations including various techniques, methods, and configurations for creating and controlling a virtual computing environment. Then various template structures and methods and techniques for creating and using templates are described relative to physical and virtual computing environments, including in a server based virtual machine environment using thin client workstations.

### Exemplary System and Device Architecture

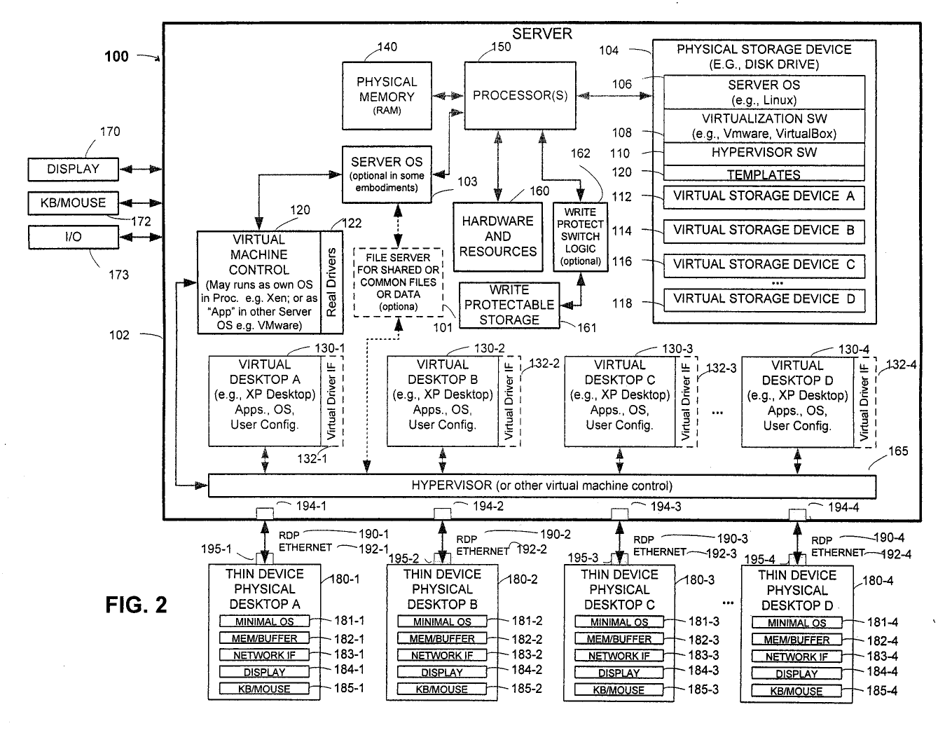

One non-limiting system embodiment 100 of the invention, such as of the embodiment in FIG. 1, is now described with reference to FIG. 2. A computing machine such as a server 102 implements a control environment and at least one, but more typically a plurality of, virtual machines 130-1, . . . , 130-N. These virtual machines are also referred to in this particular embodiment as virtual desktops for reasons that will become more apparent in the descriptions to follow, and in the embodiment illustrated here, four such virtual machines 130-1, 130-2, 130-3, and 130-4 are illustrated and described. System 100 may support any number of virtual machines and/or virtual desktops, and the number may be limited only to the extend that available memory, processing power, and/or communications may limit or degrade the performance.

The physical hardware of server 102 may be based on a conventional commodity computer, such as a computer made by Hewlett-Packard, Dell, Compaq, or other computer manufacturer, and may include a processor 150 (such as a central processing unit or other processor logic) coupled with a physical memory such as a random access memory (RAM) 150. The processing and associated physical memory being adapted to execute computer program code instructions and optional data, including for example executable instructions. The invention is not limited to any particular processor 150 type, operating system, or computer or server architecture.

A physical storage device 104 for persistent or non-volatile storage of operating system, data, applications programs and the like is provided. program information. Storage device 104 may be referred to as a mass storage device and is conventionally provided by a hard disk drive storage device or an array of such devices configured as a single logical unit or as multiple logical units, such as a RAID storage array. The invention is not limited to any particular physical or logical storage device 104 configuration.

One or more additional write protected or write protectable storage device or subsystems 161 may also be provide to advantage as will be described hereinafter. In one embodiment, the write protected or write protectable storage 161 is a read-only storage when a write protect switch or switch logic 162 is in a first state where reading is permitted but writing to the device is prevented and in a second state where writing to the device (as well as reading) is permitted. This write protected or write protectable storage is coupled through the write protect switch logic (such as a physical switch, switching logic, or the like) to the processor or processors 150. Read and write operations (when permitted) may take place between the write protectable storage, and the physical storage device 104 as well as with physical memory or RAM 140. Embodiments of the invention may be implemented by any known media type, but at least some embodiments of the write protectable storage 161 are implemented with solid state memory such as compact flash, Sony Memory Stick™, or other solid state memory with either a separate or an integrated write protect switch or switching logic 162. As will be describe hereinafter, the write protectable storage 161 may advantageously be used to store a pristine trusted copy of a template or master template from which system recovery, restoration, or repair may performed. In one embodiment, the contents of the write protected storage 161 may also be used as a computing device boot source.

Server 102 may be coupled to a display device 170 through a display adapter (not shown), a keyboard and mouse 172 or other interactive user device, and optionally with other input/output devices as are known in the art. The display, keyboard, mouse may be used to configure, diagnose, update, monitor or otherwise provide an interaction means between an external user and the server 102 as well as with other system 100 components.

Server 102 may include different or additional hardware and resources 160 as are conventionally known in the art, and not described in further detail herein, to avoid obscuring features on the inventive system.

Server 102 is adapted to implement virtual machine environments. In one embodiment, the server computer 102 has installed and executes machine virtualization software 108 that is used to configure or partition the server (and effectively the workstations or client machines) into separate virtual machines within one or a smaller number of physical machines (rather than into different physical machines). Each of the virtual machines includes or contains its own copy of an operating system. Different machines may include, contain, and implement a different operating system (such as for example, any one of any Microsoft Windows OS, Linux OS, Unix OS, Netware, Apple OS, or the like) as may be appropriate to a client workstation or server machine implementation.

Various different virtualiztion techniques are known and others are evolving. The present invention may be implemented with any of the known virtualization methods and techniques as well as those that are still evolving. In some implementations the virtualization software somewhat or entirely replaces a computing machines operating system, while in other virtualization implementations the virtualization software more of less executes on top of the computing machine's operating system somewhat in the manner of an application program. Other implementations provide an approach that is a hybrid or mixture of these implementations. Hybrid virtualization technology may include software code that can be stored on any data storage device and subsequently executed by any data processing device. In one non-limiting embodiment, for example, the program may be stored in ROM, (or EEPROM) on a motherboard or as part of a motherboard's chipset, or as part of an attached daughterboard, or as part of the firmware code of a BIOS, a processor's microcode, or a separate PCI card. The software code may then be read into a processing device that executes the code and delivers the virtualization results at any level of the software stack. Portions of the software code may reside in one or a combination of these locations, or within any other device that is capable of storing data, and then executed on any combination of devices capable of doing so. In some exemplary non-limiting embodiments, the virtualization technology may be considered to reside or execute “underneath” the OS, for example, when, for example, time divisional multiplexing of the processor is executed immediately upon system boot.

As the interest in computer virtualization increases, developers continue to evolve and develop new implementations, so that discrete models for virtualization are difficult to define as many contemporary implementations are hybrid. Once the virtualization software 108 and/or Hypervisor software 110 are loaded and launched, they create and control the virtual machines.

Independent of which virtualization method or technique is utilized, some means for creating the virtual machines is required. The inventive system also incorporates means for running the hypervisor on the server computer or machine, such as a server operating system. In one embodiment, a Linux operating system is used on the server that is running VMware Server, which is a hypervisor and creates Virtual Machines that are loaded with and running Windows XP on each virtual machine (VM). This embodiment also provides for implementing the control into the server (host) operating system, which in the present example system means that the Linux host OS runs VMware and also provides the control. Alternatively, the control may be implemented in a virtual machine. Other implementations for virtual machines may not have a host operating system in a traditional sense, in that they do not have or use full blown conventional operating systems; however, it may be appreciated that some level or operating system or operating system like layer or code may typically be needed to function as the hypervisor.

In one embodiment, server 102 executes Virtualization software from VMware, Inc., Palo Alto, Calif. (www.vmware.com). In this embodiment, Server computer 102 executes a server operating system software 103 (such as Linux) that is loaded from the server OS software 106 stored on the physical storage device 104. The VMware virtualization software then creates virtual machines or workstations 130-N as is known in the art, each executing its own copy of an operating system (OS) and selective applications. VMware currently supports Windows, Linux and NetWare, and resides as a layer between the hardware and the virtual machine partitions. In one embodiment, the VMware is used to create a plurality of separate virtual machine desktops each executing a Windows XP operating system.

In a different embodiment, server 102 executes Virtualization software through VirtualBox, developed by Innotek GmbH, Stuttgart, Germany (www.innotek.de). Following loading of a server operating system software 103 that is loaded from the server OS software 106 stored on the physical storage device 104, VirtualBox creates virtual machines or workstations 130-N as is known in the art, each executing its own copy of an operation system (OS). In one embodiment, VirtualBox is used to create a plurality of separate virtual machine desktops.

As is known in the art, a virtual machine is one instance or instantiation of an operating system running in a “virtualized” computer (here server 102) that is running two or more copies of the same operating system or two or more different operating systems. The virtualization is accomplished by a layer of software called a virtual machine monitor (VMM) or hypervisor 105 that resides in a layer between the physical hardware and the guest operating systems. Typically, each instance of the operating system runs its own applications as if it were the only operating system in the computer. Usually the operating system runs without modification unless the virtual machine monitor or hypervisor is based on a para-virtualization method, such as a para-virtualization method implemented by Xen. Para-virtualization is a virtualization technique in which the virtual machine monitor or hypervisor creates virtual machines that are similar but not identical to that of the underlying physical hardware. Xen is an open source virtualization software that is used to partition workstations and servers into separate virtual machines, each containing its own copy of an OS. Xen advantageously provides fast response and low overhead, at least in part because it provides a small low-level hypervisor which is the first control software loaded when the computer starts up.

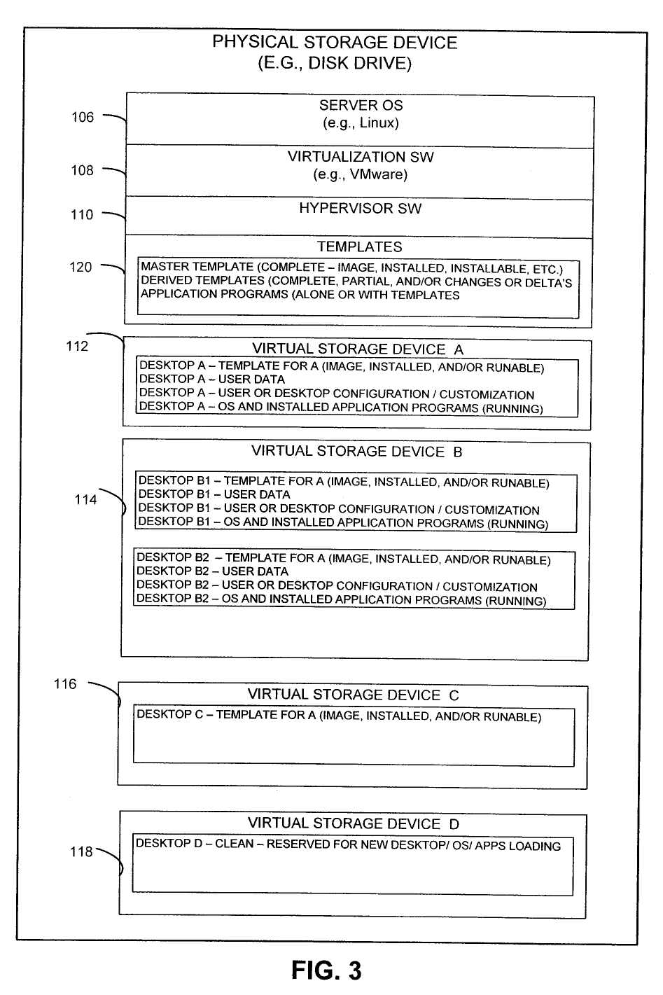

In an alternative embodiment, a para-virtualized virtual machine (VM) environment provides and uses one or more privileged guest operating systems for handling the actual physical device drivers for the hardware. This is the virtualization approach taken by Xen. It is somewhat unlike other VM environments where the OS runs as is, in that an OS runs on top of Xen and must be ported to call Xen virtual drivers which then in turn call the real physical device drivers. The real drivers run outside of Xen, and the machine can always be booted into a consistent, secure base configuration. It may be noted that there may usually be no requirement to port the operating system to Xen if the hardware platform offers support for virtualization, such as Intel's VT, AMD's Pacifica and IBM's POWER5 architecture. Further information concerning the features of Xen may be found at Xensource (www.xensource.com), which information as of the filing date of this application is hereby incorporated by reference. This is an approach that is illustrated in the embodiment of FIG. 3, however, it will be appreciated that the virtual machine software (whether a VMware-type implementation, a Xen-type implantation, some hybrid, or an entirely new implementation approach) may be executed either as a real process within the server computer 102 or within a virtual machine 120 as suggested by the implementation in FIG. 3.

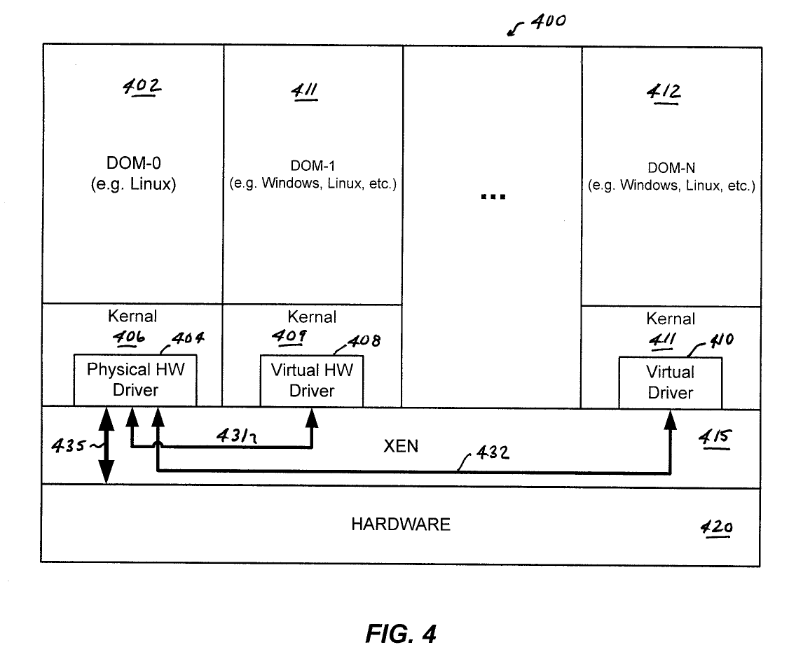

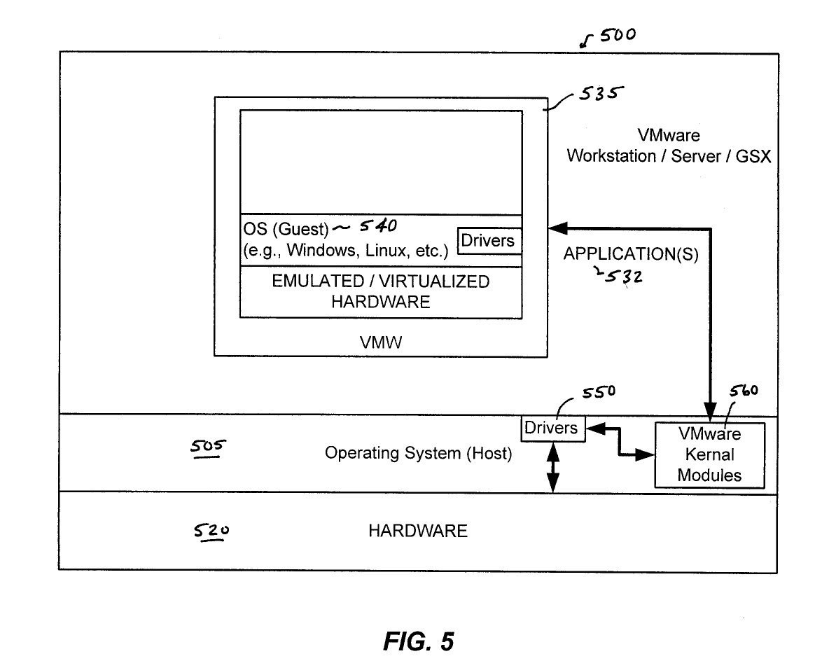

The virtualization process may alternatively be described in terms of layers and interactions between layers. FIG. 4 and FIG. 5 illustrate by way of schematic diagrams, alternative embodiments for Xen (FIG. 4) and VMware (FIG. 5) type virtual machines. One of the difference between VMware and Xen implementations, is that for the Xen-type implementation 400 one has a Domain zero (DOM-0) region 402 where the actual or physical drivers 404 within a kernel 406 that talk to the virtual drivers 408, 410 exist, and the virtual machines has a domain (DOM-1, . . . , DOM-N) 411, 412 that sit along side that Domain zero region 402. The Xen layer 415 provides a means for communicating between the virtual machines and domains with the hardware 420 using effective paths 431, 432 between virtual hardware drivers 408, 410 and physical hardware drivers 404. The Domain 0 kernal physical drivers 404 then interface with the hardware layer 420 via path 435.

By way of comparison, a VMware type implementation 500 as illustrated in FIG. 5, may provide for a relatively thick or fat layer 502 sitting on top of the Linux (or other) host operating system 505, which itself sits on top of a hardware layer 520. In this implementation, the VMware (VMW) 530 runs as an application 532 within the Linux operating system environment 505 and creates the individual virtual machines 535, into which is installed the guest operating system (here Windows XP) 540. The guest operating system or OS (here Windows XP) in turn has a remote desktop protocol that supports communication with the host. Communications may then be supported between the host and any client via a hardware interface card over the Ethernet. The host operating system provides drivers 550 and VMware kernel modules 552 that provide an interface between the applications 532 executing as or in the virtual machines, and the hardware layer 520 via the VMware kernel modules 560 and communication paths 552, 553. In the VMware environment, the VMware time-multiplexes, multi-tasks, or in other ways provides for sharing of the server resources (e.g. processor, memory, and the like) so that each virtual machine gets its appropriate share based on various equity, policies, priority, and/or rules relative to that sharing. In one aspect, the hypervisor (either as a VMware or as a Xen, for example) manages virtual containers and the particular location where the hypervisor functionality resides may depend on the particular implementation. In principle, the hypervisor may exist in several places so that in a hybrid VMware and Xen implementation, the hypervisor functionality may not and need not be centralized. Furthermore, control of and/or by the hypervisor can happen at system BIOS level, from an operating system, from VMware, from Xen, directly from a server operating system, from a Virtual Machine, or from any other element or combination of elements the server, or even from elements outside of the server. In one embodiment, control of and/or by the hypervisor may be managed by another virtual machine, client computing machine, server, or other external system communicatively couple to the server.

It may be appreciated that aspects of the invention that involve loading virtual desktops into virtual machines and memory based on templates do not depend on the particular manner in which virtualization or control are implemented or achieved. Furthermore, not only may the nature of creation of the virtual machines into which the templates are loaded, but also or alternatively the manner and location of the control of the virtual machines and/or hypervisor may vary, so that aspects of the invention are not limited to particular virtualization methods or structure.

The descriptions of virtual machines and techniques for creating and controlling virtual machines that are created and executed in a server computer are described here in such detail that aspects of the invention may be more readily understood; however, it is beyond the scope of the description here to provide a detailed description of all aspects of machine virtualization or conventional computing hardware or software.

The inventive system 100 and server 102 may be operated with either a para-virtualized virtual machine (VM) environments or a non-para-virtualized virtual machine (VM) environment, with appropriate changes to the configuration. Virtual machines in general, and the implementation and use of para-virtualized virtual machine (VM) environments and non-para-virtualized virtual machine (VM) environments are known in the art and not described herein in further detail.

In accordance with either type of virtual machine implementation, a plurality of virtual machines are created. In one non-limiting embodiment, one of the virtual machines implements a virtual machine for control 120 of the server and the other virtual machines, while the other virtual machines implement virtual desktops 130-1, 130-2, 130-3, and 130-4. Although the embodiment of FIG. 2, illustrates a one-to-one correspondence between each virtual desktop 130-N and the thin physical desktops 180-N, it will be appreciated that there may be other than a one-to-one correspondence. For example, the control environment (in what ever form implemented) may spawn, create, or initiate only one or a plurality of virtual machines or virtual desktops. Different embodiments of the invention may also or alternatively provide a single virtual machine that is associated with a thin device physical desktop that provides an operating system and a single application program, that provides an operating system and a plurality of application programs, that provides a plurality of operating systems and either a single or a plurality of application programs, and/or that permits the user of the thin device physical machine and desktop to initiate a plurality of virtual machines each having any of the single or plural combinations of operating systems and/or application programs as described above. These various alternatives provide different levels of user, machine, application program, and data isolation and immunity to hacker, virus, spy-ware, and/or other malicious code.

With further reference to FIG. 2, server 102 may generate one or a plurality of virtual machines that may for example execute a virtual desktop 130-N for a corresponding physical machine 180-N. A user of the physical machine may have the impression that she/he is executing an operating system and one or more application programs on that physical machine, however, in fact most or all of the processing is being carried out using resources (such as processor 150, memory 140, and storage 104) of the server.

In one embodiment, the computing machine 180-N one which the physical desktop appears is advantageously a thin device physical computing machine. The term thin is understood in the computing arts to be a computing machine that has some minimal processing storage, hardware, and/or software resources or it may have none (for example it may be a dumb terminal). Typically a thin machine (also referred to as a thin client when the environment presents a client-server relationship) has a lower capability processor (e.g., lower processor clock speed), a smaller amount or RAM memory, and little or no persistent or non-volatile storage space (e.g., no hard disk drive). Although the inventive system may utilize even high-performance devices for the physical desktop 180-N, the advantage arises from the lower costs achieved via the use of thin machines. The capability of using a thin device is also advantageous so that older computing machines that were once perhaps relatively high-end machines, but after a period of a few years are not suited for contemporary processing, may be used as the computing machines 180-N. In this way, high levels of performance may be achieved by using the resources of the server (or of a plurality of servers) to provide the desired level of contemporary processing capabilities. Therefore it will be appreciated in light of the description provided here, that although a thin computing capability is entirely adequate and that for the system 100 as described, the use of non-thin computing machines, including for example very high end computing machines will not materially improve performance of the system as the resources of the client side machines need not be utilized.

For example, in one non-limiting embodiment, the client-side machine is a thin client machine 180-1. In a non-limiting embodiment, the thin device physical desktop machine 180-1 provides a minimal operating system 181-1, a memory or buffer 182-1, a network interface (IF) 183-1, a display interface and display device 184-1, and means for user interaction with the machine such as a keyboard and mouse or other pointing device (KB/mouse) 185-1. The memory or buffer will be user stood to require only a minimum temporary storage or buffering capability so that user inputs (such as keyboard strokes), display data or frames, data waiting to be sent across the network interface and data received from the network interface, and other temporary storage is provided. Although a mass storage device such as a hard disk drive may be utilized for this purpose, it is not required, and for new implementations is disadvantageously provided because of the cost of such hard disk drive devices. Memory for buffering data may be implemented in any existing RAM that may be available on the new or reconfigured legacy machine, and such buffering may be provided in a single memory or buffer device or with a combination of memory of buffer devices. For example, memory or buffering for the network interface may be provided on or within a network interface card (NIC) or chip, memory or buffering for a display may be provided on a display interface card or chip or frame buffer, and memory of buffer for any other temporary storage may be provided within any other available memory available within the device. Embodiments of the invention may utilize so called system on a chip (SOC) technology since the hardware requirements of the client side machine are so minimal.

In addition, the operating system requirements 181-1 of the client side machine are also minimal. In fact the operating system requirements of the client side machine may be considered to be considerably less than what is considered to be an operating system. Basically, the operating system only needs to be able to support user input, symbolic or graphical display, interaction and communication with the network (via the network interface), and any temporary memory or buffer management. In one non-limiting embodiment of the invention, the client side machine operating system is provided for example, but not limited to, by a Centos (Linux) OS or Knoppix. It will be appreciated that the client-side computing machines or devices may be either the same or similar (homogeneous) or different (heterogeneous) devices in terms of hardware and/or operating system.

In one non-limiting embodiment, the (each) client side machine 180 is coupled with the server via an Ethernet communication link 192 via an Ethernet enabled network interface 183 on the client side and one or more Ethernet network interfaces on the server 102 side. A single server side Ethernet interface is sufficient when it is Centos (Linux). Advantageously, a plurality of Ethernet interfaces or Ethernet interface ports within a single Ethernet network interface may be used. Internal connections of the one or more Ethernet ports is not shown to avoid obscuring the inventive aspects of the system, server, and client workstations. Gigabyte Ethernet implemented in one embodiment to provide communication at a rate of 1-Billion bits per second. Devices and methods for connecting or coupling client side devices with a server using Ethernet network interfaces are known in the art and not described further here. It will be appreciated that Ethernet and Ethernet enabled network interfaces are only one example of means for coupling the client side devices to the server and that other and alternative means may be used. Furthermore, different communication links, devices, and methods may be used for the different client side machines.

In one embodiment, a Remote Desktop Protocol (RDP) 190 is used to support communication between the clients 190-1, . . . , 190-N and the VM's server 102. While various remote desktop protocols are known in the art and may be used, the system may advantageously use Freenx which is open source.

Workers in the computer and computing arts will understand that hardware drivers are needed to provide an interface between hardware and operating system and application programs. In a simple single user computers having a defined set of physical hardware, the operating system and/or application programs may interact directly with the physical hardware as is known in the art. In more complex virtual computing systems, different virtual machines may need, have, interact with, utilize, or see different hardware. This different hardware may be real physical hardware or may be hardware that is mapped to, virtualize, or emulated to appear to be the same, similar, or even different hardware. These drivers are known on the one hand as real or physical drivers; and, on the other hand as virtual or emulated drivers, as are known in the art.

Physical storage device 104 may usually be implemented as a rotating hard disk drive; however, it may be understood that any storage device or combination of storage devices may be used as are known in the server and/or storage arts. The storage device is referred to as a physical storage device to somewhat distinguish from logical or virtual storage devices that may be mapped onto or defined within the physical storage device. In one embodiment one or more write protected or read-only write protectable media may advantageously be used to securely.

Write protectable data storage is known in many forms. For example, Small Computer System Interface (SCSI) storage devices have a dip switch controllable hardware write protect feature. Universal Serial Bus (USB) storage devices may also have switch control. Solid state memory devices such as compact flash, secure digital, Sony memory stick, and other devices either have or may be modified to provide for a write protected or write protectable media so that once a known and trusted virus, hacker, and malicious code free set to operating system, application program, data, and other information has been prepared by a trusted source, that media can be locked from further write operations to protect it from contamination.

As will be further described relative to templates, in one embodiment of the invention a trusted entity, such as a trusted administrator who has physical access to the hardware, creates master templates (and possibly secondary or derivative templates) and puts them on secure write protectable media. If there is a failure, contamination, suspected contamination, the templates cannot be deleted or compromised by an unauthorized write operation. This is particularly true where it is made physically impossible to write to a write protected media, and where no software operation is able to override that write restriction. The template is created with write enabled, then disable write with a switch to lock out further write operations. A pristine trusted master template is created on a pristine machine, then throw the switch to lock it into the template. The template storing write protected machine may then be installed in a different machine.

The write protected storage may also be used as one of the possible boot code sources for a boot loader, in addition for example to the normally read-write hard disk drive. The boot loader is frequently the first software program that runs when a computer is powered on or initializes. It is responsible for loading and transferring control to the operating system kernel software (e.g., Linux). The kernel, in turn, initializes the rest of the operating system.

In the event that some element of the system or software, or user or administrator intuition suspects that a failure or problem may have occurred, or if part gets erased or crashed, the boot loader may offer a choice of fixing the computer now during the boot. A self-repair script is executed to restore the operating system and templates back from protected storage to read-write disks to get the system up and running as before the failure or suspected failure. The script may even offer the user a choice of levels of repair as described in the related applications incorporated by reference herein. The computer may also be set up to recognize a failure situation and automatically and without user intervention to make repairs using templates stored in the write protected storage. Authorization to make the repair may optionally be requested by the computer to the user or administrator before carrying forward with the repair.

Physical storage device 104 may store the server operating system 106, virtualization software 108 (such as for example VMware or Xen virtualization software), and hypervisor software 110. Physical storage device also provides a virtual storage device for each of the virtual machines 130-N implementing the virtual desktops. Original versions or copies of complete operating systems or components, application programs or components, templates, or any other command, control, and/or data elements may also be stored in the write protected or write protectable memory 161.

Depending upon the particular implementation, such as a VMware type implementation or a Xen-type implementation, the guest operating system in the virtual machines may talk to emulated (typical of a VMware implementation) or a virtualized (typical of a Xen implementation) devices.

### Exemplary Embodiments of Templates and Methods for Creating and Using Templates

Templates are predetermined or in some instanced dynamically determined sets of computer program software that include executable instructions and optional data for operating all or part of a computer. Various types of templates are described in the related U.S. patent applications identified on the first page of this patent application.

Embodiments of master templates in the afore mentioned related patent applications were described as a backup of data, representing a computing system according to an ideal state. The ideal state typically included an operating system, a collection of applications or software, and the data included in the master template may have been specifically chosen for a particular user and for a particular hardware configuration.

A master template may be created or updated according to a variety of approaches. One approaches involving a data storage device may include: (1) Creating several backups of data on a data storage device over time; (2) An activity associated with the backup process, such as a repair process is triggered; (3) A backup of user data files is performed (e.g., to save the users current work); (4) Existing data storage device (e.g., memory) may be reformatted or tested, and may be performed according to preferences for that data storage device; (5) The master template is copied to the user data storage device; and (6) Backup of user data files is restored to the user data storage device. The computing system may thereby be restored to a normal operating state with minimal user intervention.

The master template may also be updated, changed, or modified in a variety of ways including: by the user, by access to an update (e.g., an incremental release by a computer manufacture), or by access to a replacement master template, or the like. The preferences associated with a master template may provide a method for performing these modifications.

The master template may be tested to ensure the master template and the repair process functions as expected in the backup process, such as restoring the computing system. This testing helps ensure the functionality of the master template, the restore process, and may also be used as a virus check and repair. An on-line service may be provided to detect virus, verify the integrity, or to update a master template. Additionally, the master template may include a copy or an ideal-state version of the BIOS settings.

The related applications also describe various techniques for backing up a system to create a new and current master template that includes a current state of the system, optionally including user data. The new master templates may also include some, selected, or all updates from the original installation so that it is unlike a system software restore CD or DVD that is occasionally provided with a new computer purchase. These system software restore CD or DVD do not create an updated current copy of a last known computer software that would for example include an operating system, updates or patches to that operating system, application programs, drivers, and/or other system software components installed since the conventional restore CD or DVD was manufactured, nor will it include user data. Furthermore, even if a conventional back-up of some type was made, that back-up might not be trusted since it might have already been contaminated with a virus, hacker code, spy-ware, or other malicious code.

Embodiments of the invention extend the structure, creation, and use of templates and master templates in a variety of ways that are particularly adapted to a server based computing configuration. The server may be one that serves a plurality of client machines having their own processors, memory (RAM) coupled to the processors, and some type of storage device for storing program and user data in a persistent or non-volatile manner when the client machines are powered down. The storage device may conventionally be a hard disk drive storage device but may alternatively on additionally include solid state nonvolatile storage, optical storage, or other storage as is known in the art. However, the server may also be a server that itself provides all or substantially all of the processing in a server resident processor or processors, server resident memory coupled to the processor or processors, and server based storage (either within the server or using some type of server attached or accessible mass storage device). The client computer or workstation may in this situation be a thin or very thin client device or event what has conventionally been known as a dumb terminal. Furthermore, significant computing may be realized from what might be considered to be a sophisticated device but that is still thin relative to conventional desktop computers, notebook computers, or the like. Embodiments of the invention may even support a local non-server based processing using client side machine resources and a server-client based processing using primarily the server side processing resources.

Even greater advantage may be realized when the server is adapted to generate and control a plurality of virtual machines within the server, to associate virtual machines with thin clients, and to control the allocation of resources in the server to provide the processing capabilities needed by users of the thin client machines. In this situation, and given a sufficiently high-speed client-server connection, the user of the client side device may or should not be aware of any significant slowdown or processing limitations.

The virtual machine realized client server configuration in conjunction with the inventive structure and use of templates also provides the client side user with immunity to viral, hacker, spy-ware, and/or other malicious code or attack.

A template provides a convenient container for storing some complete version of the computer program software that may generally alleviate much or all of the need for building the computer program software needed or desired to operate the computer. For example, in one non-limiting embodiment, a template includes the operating system, application programs, user customizations and preferences, and the like in any combination, and in a ready to execute form. It is therefore not necessary to separately load an operating system, add each of a plurality of application programs in order, add hardware drivers for devices that are not known to the operating system, or to customize or set user preferences or customizations.

As described herein after, templates generally as well as so called master templates provide a number of advantages for maintaining a computer software (possibly including operating system, application program, system information or data, drivers, user data or files, and the like) in a known, trusted, and infection free state; and/or, if there is a question that a viral, hacker, spy-ware, or other infection or possibly harmful situation may have arisen, to restore the computer system and software to a known, trusted, and infection free state.

Although various types of templates may be used, a novel template structure and method for building and using templates is presented here for a virtual computing environment where a plurality of virtual machines are created within a server, users access the sever through thin clients or dumb terminals, and master and secondary templates are build, stored, swapped, and otherwise utilized to provide an immune and efficient computing system. Templates are described in greater detail in the sections that follow.

In one embodiment, a complete version of a template that includes all operating system, application program, drivers, and other components necessary for execution of the virtual machine is provided. User preferences may or may not be provided in the template and if not provided may be separately stored. Separate storage of user preferences and/or customizations may provide for a multitude of users to utilize a common template without excessive storage.

In another embodiment, templates for different ones of the single or plurality of virtual computers or machines may not have or store complete copies of all operating system components, application program components, hardware real physical or virtual drivers, customizations, preferences, or other computer program components. For example, in one embodiment, one template may be constructed and stored that includes a complete or substantially complete version of the operating system, one or set of application programs, and none to several default preferences or customizations. The one or set of application programs may be either a minimal set of application programs, a full set of all the application programs that the system administrator or other controlling entity is willing or authorized to provide or install, a typical set of application programs, or a set of application programs chosen or selected in any other way.

Depending upon the rules or policies for setting up the templates (different rules or policies may be set up for different circumstances) the one template that is complete or substantially complete may serve as the basis for other templates. For example, templates for one or more of the virtual machines may merely have an indication in the form of a bit or set of bits, flags, names, pointers, or other identifying information that one of the preexisting (or to be built) templates is to be used when the virtual machine is created. Alternatively, there may be information identifying that a particular preexisting (or to be built) template is to be used as a basis for creating a new template, with additional information that may for example identify additions, deletions, modifications, or changes to that identified template. If the preexisting template contains the operating system and all application programs, then the additional information may identify application programs to be deleted. The deletion may, for example, be desirable if application program licensing fees might be due upon installation for the program rather than upon use, or where a site license is only available for a predetermined number of copies of the application program. The deletion may also be selected where the new template will include some additional component that is incompatible with an operating system element, application program, driver, or other component of the origin template on which the secondary template is to be based.

More typically, the origin template is a minimal template or a typical template that includes an operating system (OS) and some set of application programs, drivers, and other components used in a minimal or typical computing system. One exemplary but non-limiting typical computing system may have a Windows XP Professional operating system installed, plus a word processing application (such as for example, Microsoft Word), plus a financial accounting program, plus an Adobe Acrobat Reader application. If this is the base origin template, then if a virtual machine for a particular user also requires an image processing and manipulation program like Adobe Photoshop CS2, then the particular secondary template for that virtual machine will include the additional application program or an indicator or pointer to that additional Adobe Photoshop CS2.

The origin template that is used as a basis for secondary templates for the virtual machines is advantageously structured and stored in a manner that additional components may readily be added, deleted, and/or modified. In one embodiment, all of any needed components are included in the origin template and in the secondary template but with appropriate pointers or other indicators in each to identify active from inactive code sections. In one embodiment, the structure of the operating system code segments and of the application program code segments are modified from their form in a conventional installation so that they are somewhat modular and can more readily be enabled (activated) or disabled (deactivated). In one embodiment, the code in the template is built in a modular manner with some redundant code sections that are activated or deactivated when the secondary template is constructed or when it is executed. In one embodiment, various pointers are used to designate enable or disabled sections of code. In one embodiment, deactivated sections of code are actually deleted and removed by a program modification procedure before loading and execution. In one embodiment, a Windows Registry file is modified to provide some customization or adaptation of the virtual machine template. In one embodiment, a Windows or other operating system type registry file is used to achieve a degree of customization. These and any other technique known if the art for modifying computer program software so that sections of the computer program software are rendered operable (active) or inoperable (inactive), and/or for linking computer program code segments together so that the linked parts form an operative whole may be utilized.

Advantageously, these templates may be in a ready to load and execute form. Alternatively, they may be in some runnable state, such as in a hibernation like state with execution suspended in some manner. Other embodiments may provide for different versions or states of a template from source code that needs to be compiled alone or with other code segments to suspended execution versions or states of the template.

In one embodiment, there may be one or more application programs (applications) per origin or master template. Thus, one computing environment may run with an OS and Microsoft Word, while another computing environment may run with an OS and a gambling software application. Any combination is possible. Optionally, different templates or master templates may be provided for parent/child.

In one embodiment there may be provided parent-child relationships between templates so that instead of or in addition to having a master or origin template, there may be parent-child relationships (with any degree of recursion) between and amongst templates. The relationships may be that these parent-child template relationships may involve replacement of code and or data segments.

As described above, creation of virtual computing environments according to at least one embodiment of the invention generates derivatives of the origin or master template. These derivative templates may be characterized in a variety of alternative ways. For example, each derivative template may be characterized as an instance of the original master template, so that for example, if there are four virtual computing environments A, B, C, and D created, there will be a derivative template Instance A, Instance B, Instance C, and Instance D. There may also be fifth instance for a control environment.

A second alternative characterization is that the master template derivative templates may be regarded as parent-child-grandchild type relationships, or as a sibling relationships, or as mother-father-daughter-son type relationships.

In one embodiment, the master template includes an operating system (or operating system components), one or more applications or application programs, and optionally one or more user custom settings. In one embodiment the user custom settings when present may be a default user setting or a plurality of default user settings.

User settings may for example include any one or more of the following: desktop pattern, printer preferences, default fonts, and any other of the user preferences and/or customizations that may typically be supported in known computer systems, software, operating systems and the like.

The original master template or a derivate template or derivative master template by be stored or exist in any one or more of several alternative forms, and more than one form may exist or be utilized in a system.

By way of example, but not limitation, the following forms are possible:
(1) Template is copied to a storage device such as a hard disk drive (HD) but not installed.
(2) Template is installed onto the storage device.
(3) Template is stored on the storage device as a copy of an installed version.
(4) Template is stored as a running version in RAM or in persistent storage.
(5) Template is stored as a hibernating version in RAM or in persistent storage.
(6) Template is stored in RAM for rapid creation or duplication of another instance of the template but is not itself the template to be used for the new instance.
(7) Template is stored in a write protected storage in any one of the installed version, running version, hibernating version, or stored for rapid creation or duplication of another instance of the template but is not itself the template to be used for the new instance.

These options apply to virtualized computing machines as well as to non-virtualized computing machines and to computing machines that include real physical non-virtualized computing machines or workstations as well as one or more virtualized workstations.

In one embodiment of the invention, the use of derivative templates provides an opportunity to generate different templates for different computing environments, including for virtual computing environments, in which actually or potentially incompatible application programs, drivers, user preferences, configuration, version, or other specialization or customization. The incompatibilities may be for the same or different operating systems, or versions of operating systems, combinations of operating systems and application programs, combinations of application programs executing under the same operating system, combinations of operating systems or application programs with different dynamic load libraries (DLL's), or any other actual or possible conflicting build, configuration, or combination.

These options are independent of operating system (e.g., Microsoft Windows 2000, Windows XP, Windows Vista, Linux, Unix, Apple Operating system, or any other operating system) or application program (e.g., MS Word, WordPerfect, Adobe Acrobat, Adobe Photoshop, Quicken, Excel, or any other application program).

For example, in the event that a particular operating system, OS Z, may be compatible and properly execute application programs “AP 1” and “AP 2” separately, but for some reason either one or both of the application programs will not execute properly when they are both installed to OS Z, then a derivative template may be built that only installs AP 1 but not AP 2 or selectively deactivates AP 2 may be generated when a user requests the launch or initiation of AP 1. As described herein elsewhere in this application and in the incorporated by reference related applications, the derivative templates may be created very rapidly so that the user requesting launch of an application program will not be aware of any delay.

In one embodiment, this selective inclusion or exclusion (in whole or in part) may be implemented using a dynamic coupling of the OS with other application program, driver, configuration, and/or user preference or option elements. Each computing environment may therefore have a private version of the operating system with that version's own delta changes or differences in that operating system or in the application programs or other elements.

FIG. 3 is an illustration showing conceptually that manner in which an original master template may be modified or copied and the copy modified to provide specialized alternative sections for different instances of the computing environment. A derivative version template 42 of original operating system template 41 (possibly including application program elements, registers, or other computing environment components) is modified to provide customizations for a father OS or template difference (or father instance) 44, a mother OS or template difference (or mother instance) 45, a daughter OS or template difference (or daughter instance) 45, and a son OS or template difference (or son instance) 46.

Differences (deltas) may provide or a variety of differences such as OS changes or differences, Windows registry changes or differences, application program changes or differences, DLL changes or differences, and/or other changes or differences to achieve the desired operation.

In one embodiment, the storage device on the server stores a pristine copy or version of a template for each of the virtual machines A, B, C, and D (e.g., VM-A, VM-B, VM-C, and VM-D). In one embodiment, each of these pristine templates may be disk images for VM-A, VM-B, VM-C, and VM-D. In one embodiment, these disk images include instances of the operating system (OS) and any user applications as well as optional user preferences or customizations. Each virtual machine (user machine) may have its own unique OS, application program, and user preferences of characteristic. Alternatively, embodiments may provide for identical or substantially identical templates without availability of persistent user customization. In other words each time a virtual machine environment is created it may not recall prior user customizations as such customizations or preferences are retained only during the execution of the particular user or virtual machine session in which such customizations were identified.

In one embodiment, a particular virtual machine template is created on the fly substantially in real time when a user selects an application program for execution, such as for example Microsoft Word application. In this situation the template may only include operating system and application program components required to execute Microsoft Word, and optionally to utilize other typical computer capabilities such as printers, scanners, calculator, and/or other capabilities and/or features that might typically be desired or required by a user when executing Microsoft Word.

In another embodiment, the system may recognize an attempt to log on by a user and upon that recognition, build an operating system and application program template (optionally with particular user preferences) so that the user may have available a particular suite of OS and application program capabilities that the user has previously identified.

In another embodiment, the user upon accessing the system my be presented with a menu of OS and application programs that are available (or potentially available) and upon the user identifying those capabilities that the user desires to have available, the OS and application program template is custom built or assembled to provide the desired capabilities. In the event that the suite of OS and application programs that the user desires to have available represents an actual or potential problem in terms of compatibility, the system may inform the user of the actual or potential incompatibility and provide an interface for making an alternative selection or for deselecting one or more of the incompatible programs.

It will be appreciated in light of the description provided herein, that since each of the VM computing environments is separated and isolated from the other user VM computing environments, that at least one file at a time is immune to virus, hacker, spyware, and other malicious program code. On the other hand, since in this particular embodiment, a user may initiate multiple computer programs (for example, Microsoft Word and Adobe Photoshop CS2) unintentional execution of a viral code in MS Word for a user MS Word .doc file may cause a contamination of a user Photoshop CS2.pst file (whether open or not open during that session).

In an alternative embodiment, separate virtual machines are created for even a single user so that the single user's MS Word and Adobe Photoshop CS2 programs and user files are opened in separate virtual machines, thereby maintaining an isolation of the two (or more programs and files) and preventing cross contamination and thereby providing to virus, hacker, spy-ware, and other malicious program code for that entire session. In another non-limiting embodiment where VirtualBox acts as the hypervisor, separate virtual machines are operative in separate VirtualBox workspaces. A physical or logical switch allows the user to access and initiate data processing in a selected workspace without allowing data processing in a non-selected workspace to provide a user with the experience of multiple simultaneous data processing within a single processing environment while actually providing separate concurrent but isolated processing environment. In one aspect, a workspace may be assigned a particular function key (e.g., key F7), combination of keystrokes (e.g. Alt-tab), mouse location, or other means in which a user may select a workspace from a group of workspaces. The switching system then allows data processing to occur in the selected workspace coupled with a temporary data store without processing data in a non-selected workspace or on the write protected data store. In one embodiment, the control environment may be a separate VirtualBox workspace, isolated from the one or more workspaces associated with thin client machines, which may execute a user's program and files in isolation.

In another embodiment, each thin client machine workspace may contain additional virtual machines therein to further isolate processing such that selective processes within one virtual machine running in the selected thin client machine workspace is isolated from other data processing occurring in a second virtual machine running in the same selected workspace. A switching system comprising a logical or physical switch allows the user to access virtual machines for data processing without accessing other virtual machines where data is not processed within the same selected workspace to provide a user with the experience of multiple simultaneous data processing within a single processing environment while actually providing separate concurrent but isolated computing or processing environments. In other non-limiting embodiments, the configuration of virtual machines within virtual machines and a switching system to select between virtual machines may also be implemented in multiple layers, tiers, or other configuration.

When separate virtual machines are generated for the separate user application programs, an ability to provide an interaction between the two (or more) virtual machines and their corresponding application programs and user data, such as “cut and paste” type functionality may be provided. For example, in one non-limiting embodiment, one may select data and then transfer the selected data to a non-executable data buffer and then into a non-executable portion of a file to be copied to. Maintaining the data in non-executable storage prevents execution of potentially malicious executable code that this hidden in what the user believes to be only non-executable data.

In one embodiment, the server is provided with a selectable amount of memory that may be allocated to the server and among the virtual machines, Various procedures may be utilized for determining the amount of memory to be allocated to the server and to the different virtual machines, as well as amounts to be held in reserve for later allocation as additional virtual machines are created. The allocation and de-allocation may be dynamic or fixed according to some set of rules or policies.

In one embodiment, the plurality of OS and application program templates may be maintained as complete copies so that the template for a first virtual machine (e.g., VM-A) and the template for a second virtual machine (e.g., VM-B) are complete in and of themselves and do not incorporate or rely upon the existence of other templates. In other embodiments, the template for a second virtual machine may incorporate some or all of the template from a first virtual machine, or from a pristine virtual machine template that is not allocated or identified with any particular virtual machine.

When a root or basis template is used for creating or building other templates, the amount of memory and/or storage space save may be substantial, particularly where the variations between virtual machine templates is relatively small. In such an embodiment, only the changes or differences are stored so that the root or basis template is utilized with due regard for portions of the root or basis template which should be disregarded because they are either not used or because they are replaced by different elements in the virtual machine template that is identified to the virtual machine environment.

For example, if the root or basis template image is 2 GB in size, this 2 GB image is stored only once. If the changes for a particular virtual machine template for a virtual machine to be created are only 300 KB, then only the 300 KB of changes (possibly including some additional pointers or other information) are stored for that template. In this simplified example, 1.7 GB (minus any overhead) is saved by storing only the changes or differences.

As used herein, the term “embodiment” means an embodiment that serves to illustrate by way of example but not limitation. It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

1-13. (canceled)

14. A method for providing a client-server configured system immunity against viral, hacker, spy-ware, knowledge-bots, and other malicious code, the method comprising:
generating a plurality of virtual computing machines on a server computing machine;
coupling a server computing machine to a plurality of client computing machine devices through a communications link;
associating the plurality of client computing machine devices to the plurality of virtual computing machines;
controlling allocation of resources in the client computing machine devices through the plurality of virtual computing machines on the server computing machine;
creating and storing a plurality of templates in the server computing machine in a write protected data store, the templates consisting of a master template containing at least computer operating system components and a plurality of secondary templates derived from the master template, the plurality of secondary templates including at least an identifier of a difference between the master template and the plurality of secondary templates; and
loading and executing the plurality of templates in the plurality of virtual computing machines by the server computing machine in an isolated manner where attempts by viral, hacker, spy-ware, knowledge-bots, or other malicious code to infect program and user data are isolated in the client computing machine.

15. A method as in claim 14, the step of generating the plurality of virtual computing machines further comprises: generating the plurality of virtual computing machines on top of the operating system of the server computing machine.

16. A method as in claim 14, the step of generating the plurality of virtual computing machines further comprising: generating the plurality of virtual computing machines under the operating system of the server computing machine.

17. A method as in claim 14, the step of generating a plurality of virtual computing machines further comprises: generating one virtual computing machine from the plurality of templates dedicated to allocating resources in the client computing machine.

18. A method as in claim 14, the step of associating the plurality of client computing machine devices to the plurality of virtual computing machines further comprises: configuring the plurality of virtual computing machines to replace the operating system of the plurality of client computing machines.

19. (canceled)

20. A method as in claim 14, the step of controlling the allocation of resources further comprises: allocating resources at the BIOS level.

21-25. (canceled)

26. A method as in claim 14, the step of creating and storing a plurality of templates further comprises: creating and storing the master template to contain a version of a template that includes all operating system components, application program components, hardware real physical or virtual drivers, application program, drivers, and other components necessary for execution of the virtual machine; and creating and storing a secondary template to contain a version of a template to includes only user customizations and/or preferences of the plurality of virtual computing machines.

27. A method as in claim 14, the step of creating and storing a plurality of templates further comprises: creating and storing a master template which is a minimal template or a typical template that includes an operating system and some set of application programs, drivers, and other components used in a minimal or typical computing system for use in the plurality of virtual computing machines.

28. A method as in claim 26, the step of creating and storing a plurality of secondary templates further comprises: creating and storing templates which identifies additions, deletions, modifications, or changes to the master template.

29. A method as in claim 28, the step of creating and storing the secondary template further comprises: coupling the secondary template to the master template through (i) using some redundant code sections that are activated or deactivated when the secondary template is constructed or when it is executed; (ii) using pointers to designate enable or disabled sections of code in the preexisting template; (iii) deactivating sections of preexisting template code are actually deleted and removed by a program modification procedure before loading and execution the preexisting template code; (iv) modifying a Windows Registry file to provide some customization or adaptation of the preexisting template; or (v) using a Windows or other operating system type registry file to achieve a degree of customization from the preexisting template.

30. A method as in claim 14, the step of creating and storing a plurality of templates further comprises the step from the set comprising:
(1) copying the template to a storage device such as a hard disk drive (HD) but not installed;
(2) installing the template onto the storage device;
(3) storing the template on the storage device as a copy of an installed version;
(4) storing the template as a running version in RAM or in persistent storage;
(5) storing the template as a hibernating version in RAM or in persistent storage;
(6) storing the template in RAM for rapid creation or duplication of another instance of the template but is not itself the template to be used for the new instance; and
(7) storing the template in a write protected storage in any one of the installed version,

31-32. (canceled)

33. A method as in claim 28, wherein prior to the step of creating a template, offering the user a menu of OS and application programs that are available (or potentially available) and upon the user identifying those capabilities that the user desires to have available, building or assembling the OS and application program template.

34. A method as in claim 26 wherein prior to the step of loading the plurality of templates, offering the user or administrator a choice of restoring the plurality of templates from protected storage to read-write disks.

35. A method as in claim 26, wherein prior to the step of loading the plurality of templates, automatically restoring the operating system and templates from write protected storage.

36. A method as in claim 25, the step of loading the plurality of templates further comprises: loading program files in one of the plurality of virtual computing machines and loading user files in a separate virtual computing machine.

37. A method as in claim 14, the step of loading and executing the plurality of templates an isolated manner further comprises: executing the plurality of virtual computing machines such that: (i) at least one client computing machine receiving inputs from a user; (ii) at least one virtual computing machine coupled to the client computing machine and performing a processing activity independently of another virtual computing machine, said virtual computing machines storing data temporarily in at least one temporary data store; (iii) the server computing machine providing the plurality of templates to the virtual computing machine from the write-protected data store; and (iv) processing data in the virtual computing machine without processing data in the write protected data store.

38. A method as in claim 14, further comprising: a switching system in the server computer machine to provide the user an interface to select a virtual machine associated with a client computing machine such that data processed in the selected virtual machine is not processed in a non-selected virtual machine while providing the user with the experience of multiple simultaneous data processing.

39-40. (canceled)

41. A method as in claim 38, further comprising: providing a switching system in the client computing machine where the client computing machine is further operative using a plurality of virtual machines to provide the user an interface to select one of the plurality of virtual machines operative in the selected client computing machine such that data processed in the selected one of the plurality of virtual machines is not processed in a non-accessed virtual machine while providing the user with the experience of multiple simultaneous data processing in the selected client computing machine.

42-43. (canceled)

44. A computer program stored on a computer readable memory device comprising instructions which, when executed on a computer, perform a method for providing a client-server configured system immunity against from viral, hacker, spy-ware, knowledge-bots, and other malicious code, the method comprising:
generating a plurality of virtual computing machines on a server computing machine;
coupling a server computing machine to a plurality of client computing machine devices through a communications link;
associating the plurality of client computing machine devices to the plurality of virtual computing machines;
controlling allocation of resources in the client computing machine devices through the plurality of virtual computing machines on the server computing machine;
creating and storing a plurality of templates in the server computing machine in a write protected data store, the templates consisting of a master template containing at least computer operating system components and a plurality of secondary templates derived from the master template, the plurality of secondary templates including at least an identifier of a difference between the master template and the plurality of secondary templates; and
loading and executing the plurality of templates in the plurality of virtual computing machines by the server computing machine in an isolated manner where attempts by viral, hacker, spy-ware, knowledge-bots, or other malicious code to infect program and user data are isolated in the client computing machine.

45. A computing and information system providing a client-server configured system immunity against viral, hacker, spy-ware, knowledge-bots, and other malicious code, the system comprising:
means for generating a plurality of virtual computing machines on a server computing machine;
means for coupling a server computing machine to a plurality of client computing machine devices through a communications link;
means for associating the plurality of client computing machine devices to the plurality of virtual computing machines;
a controller controlling allocation of resources in the client computing machine devices through the plurality of virtual computing machines on the server computing machine;
means for creating and storing a plurality of templates in the server computing machine in a write protected data store, the templates consisting of a master template containing at least computer operating system components and a plurality of secondary templates derived from the master template, the plurality of secondary templates including at least an identifier of a difference between the master template and the plurality of secondary templates; and
means for loading and executing the plurality of templates in the plurality of virtual computing machines by the server computing machine in an isolated manner where attempts by viral, hacker, spy-ware, knowledge-bots, or other malicious code to infect program and user data are isolated in the client computing machine.

46. (canceled)

47. A method as in claim 27, the step of creating and storing a plurality of secondary templates further comprises: creating and storing templates which identifies additions, deletions, modifications, or changes to the master template.

48. A method as in claim 27, wherein prior to the step of loading the plurality of templates, offering the user or administrator a choice of restoring the plurality of templates from protected storage to read-write disks.

49. A method as in claim 27, wherein prior to the step of loading the plurality of templates, automatically restoring the operating system and templates from write protected storage.
